(19) United States
(12) Patent Application Publication
(10) Pub. No.: US 2021/0229317 A1
(43) Pub. Date: Jul. 29, 2021

(54) CMC Laminate Components Having Laser Cut Features

(71) Applicant: General Electric Company, Schenectady, NY (US)

(72) Inventor: Christopher Paul Tura, Nahant, MA (US)

(21) Appl. No.: 16/750,112

(22) Filed: Jan. 23, 2020

(51) Int. Cl. B28B 17/00; B23K 26/38; B32B 18/00; B32B 38/00; B23K 26/402

(52) U.S. Cl. CPC B28B 17/0036; B23K 26/38; B32B 18/00; B23K 2101/001; B23K 26/402; F05D 2230/13; B32B 2038/0076; B32B 38/0004

(57) ABSTRACT

Laminate components and methods for forming the same are provided. In one exemplary aspect, one or more features are laser cut into or along a laminate component or laminate sections thereof. The features are laser cut into or along the laminate component in an atmosphere. In this manner, and oxide layer is formed on the laser cut surfaces of the future. The features are laser cut into or along the laminate component or laminate sections thereof prior to an infiltration process, such as melt infiltration or chemical vapor infiltration. Accordingly, when the laminate component is infiltrated with an infiltration material, the infiltration material is prevented from infiltrating therethrough.

### FIELD

The present disclosure relates generally to laminate components and methods for forming the same, and more particularly, the present disclosure relates to CMC laminate components for turbine engines and methods for forming the same.

### BACKGROUND

In order to increase the efficiency and performance of gas turbine engines so as to provide increased thrust-to-weight ratios, lower emissions and improved specific fuel consumption, engine turbines are tasked to operate at higher temperatures. As engine operating temperatures have increased, components formed of ceramic matrix composites (CMCs) have been developed as substitutes for components conventionally formed of high temperature alloys, such as combustion liners, shrouds, nozzle segments, etc. CMC components in many cases provide an improved temperature and density advantage over metals, making them the material of choice when higher operating temperatures and/or reduced weight are desired.

CMCs components are typically located in the hot section of a gas turbine engine, including the combustion and turbine sections. Many CMCs components are machined or formed with various cavities or passages, e.g., for film cooling the CMC component during operation of the engine. Machining such cavities or cooling features are typically formed after an infiltration process in which an infiltration material is infiltrated into the component for densification purposes. This prevents the infiltration material from filling or wicking into the cavities. However, forming such cavities or passages after the infiltration process may be inconvenient, costly, and may require more expensive machining tools to machine the hardened infiltrated-laminate. In some instances, cooling passages are formed prior to an infiltration process. To prevent the infiltration material from filling or wicking into the formed cooling channels during infiltration, quartz rods or tubes are embedded within the cooling channels, e.g., during layup of the CMC component. The quartz rods/tubes are then removed after the infiltration process so that a cooling fluid may flow therethrough during operation of the engine. Embedding rods/tubes within such passages prevents the infiltration material from filling therein, but can be time consuming and labor intensive to embed within or remove from the passages. Moreover, the surfaces of the passages may become damaged during removal of the quartz rods/tubes from the passages, which may negatively affect the cooling performance of the component.

Accordingly, methods and a component formed utilizing such methods that addresses one or more of the challenges noted above would be useful.

### BRIEF DESCRIPTION

Aspects and advantages of the invention will be set forth in part in the following description, or may be obvious from the description, or may be learned through practice of the invention.

In one aspect, a method of forming a laminate component is provided. The method includes laser cutting a laminate section formed of one or more plies to define a feature having one or more surfaces, wherein laser cutting the laminate section forms an oxide layer on the one more surfaces of the feature. Furthermore, the method includes infiltrating the laminate section with an infiltration material, wherein when the first laminate section is infiltrated with the infiltration material, the oxide layer formed on the one or more surfaces of the feature prevents the infiltration material from infiltrating therethrough.

In some implementations, the one or more plies are formed of a CMC material.

In some implementations, the oxide layer is a silicon oxide layer.

In another aspect, a method of forming a laminate component is provided. The method includes laser cutting a first laminate section to define a feature having one or more surfaces, wherein laser cutting the first laminate section forms an oxide layer on the one more surfaces of the feature. The method also includes laser cutting a second laminate section to define a feature having one or more surfaces, wherein laser cutting the second laminate section forms an oxide layer on the one more surfaces of the feature of the second laminate section. In addition, the method includes laying up the second laminate section so that the second laminate section and the first laminate section form at least a portion of the laminate component and so that the feature of the second laminate section is positioned in communication with the feature of the first laminate section. The method further includes infiltrating the laminate component with an infiltration material.

In yet another aspect, a method of forming a CMC laminate component for a turbine engine is provided. The method includes laser cutting a first laminate section formed of one or more CMC plies to define a feature having one or more surfaces, wherein laser cutting the first laminate section forms an oxide layer on the one more surfaces of the feature. The method also includes laser cutting a second laminate section formed of one or more CMC plies to define a feature having one or more surfaces, wherein laser cutting the second laminate section forms an oxide layer on the one more surfaces of the feature of the second laminate section. The method further includes laser cutting a third laminate section formed of one or more CMC plies to define a feature having one or more surfaces, wherein laser cutting the third laminate section forms an oxide layer on the one more surfaces of the feature of the third laminate section. Moreover, the method includes laying up the first, second, and third laminate sections to form at least a portion of the CMC laminate component and so that the feature of the first laminate section is in communication with the second laminate section and the feature of the second laminate section is in communication with the feature of the third laminate section in such a way that the feature of the first laminate section, the feature of the second laminate section, and the feature of the third laminate section define a cavity. The method also includes infiltrating the CMC laminate component with an infiltration material, wherein when the CMC laminate component is infiltrated with the infiltration material, the oxide layers formed on the one or more surfaces of the features of the first laminate section, the second laminate section, and the third laminate section prevent the infiltration material from infiltrating into the cavity.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-sectional view of one embodiment of a gas turbine engine that may be utilized with an aircraft in accordance with aspects of the present subject matter;

FIG. 2 provides a side section view of an exemplary combustor and a high pressure turbine of the engine of FIG. 1;

FIG. 3 provides a flow diagram of an exemplary method for forming a laminate component;

FIG. 4 provides a perspective view of an exemplary laminate component according to an exemplary embodiment of the present disclosure;

FIG. 5 provides an exploded view of the laminate component of FIG. 4;

FIGS. 6, 7, and 8 provide top plan views of a first laminate section, a second laminate section, and a third laminate section of the laminate component of FIG. 4, respectively;

FIG. 9 provides a cross-sectional view of the laminate component of FIG. 4 taken along line 9-9 of FIG. 4;

FIG. 10 provides a cross-sectional view of the laminate component 100 of FIG. 4 taken along line 10-10 of FIG. 4;

FIG. 11 provides a cross-sectional view of the laminate component 100 of FIG. 4 taken along line 11-11 of FIG. 4;

FIG. 12 provides a schematic radial cross-sectional view of a laminate section having a laser cut feature therein according to an example embodiment of the present disclosure;

FIG. 13 provides a perspective view of a laminate section having a laser cut feature according to an example embodiment of the present disclosure;

FIG. 14 provides a cross-sectional view of the laminate section of FIG. 13 taken along line 14-14 of FIG. 13;

FIG. 15 provides a schematic view of the laminate section of FIG. 13 and depicts the laminate section in the process of being infiltrated with an infiltration material;

FIG. 16 provides a section view of a second laminate section having a laser cut feature being laid up on a first laminate section having a laser cut feature to form a laminate component according to an example embodiment of the present disclosure;

FIG. 17 provides a cross-sectional view of the laminate component of FIG. 16;

FIG. 18 provides a perspective view of a laminate section having a laser cut feature according to an example embodiment of the present disclosure;

FIG. 19 provides a cross-sectional view of the laminate section of FIG. 18; and

FIGS. 20 through 29 provide various views of other example laminate sections and/or laminate components that have one or more laser cut features along one or more external or outer surfaces thereof.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

The subject matter of the present disclosure is directed generally to laminate components and methods for forming the same. In one exemplary aspect, one or more features are laser cut into or along a laminate component (or laminate sections thereof), such as a CMC component for a gas turbine engine. The features are laser cut into or along the laminate component in an atmosphere (i.e., not within a vacuum). In this manner, and oxide layer forms or is created on the laser cut surfaces of the future. Notably, the features are laser cut into or along the laminate component (or laminate sections thereof) prior to an infiltration process, such as melt infiltration or chemical vapor infiltration. Accordingly, when the laminate component is infiltrated with an infiltration material (e.g., silicon), the infiltration material is prevented from infiltrating therethrough. For example, if the feature is a through hole or cavity, the oxide layer formed on the surfaces of the feature may prevent the infiltration material from filling or wicking into the through hole or cavity. Consequently, the design-intent features are not infiltrated with the infiltration material.

Forming laminate components in the method described above provides numerous advantages and benefits. For instance, various features may be machined (e.g., by a laser cutting technique) into the laminate component prior to infiltration. Thus, there is more flexibility than when the features are machined into the laminate component. For example, individual plies may be laser cut prior to lay up, laminate sections of a preform may be laser cut, a fully laid up preform may be laser cut, or a green state component (i.e., the component state prior to firing and infiltration but after debulking/compaction) may be laser cut. Further, placeholders (e.g., quartz rods or tubes) need not be inserted into the features to prevent infiltration into the design-intent cavities or removed therefrom after infiltration. Forming laminate components in the method described above may provide other advantages and benefits not explicitly listed herein.

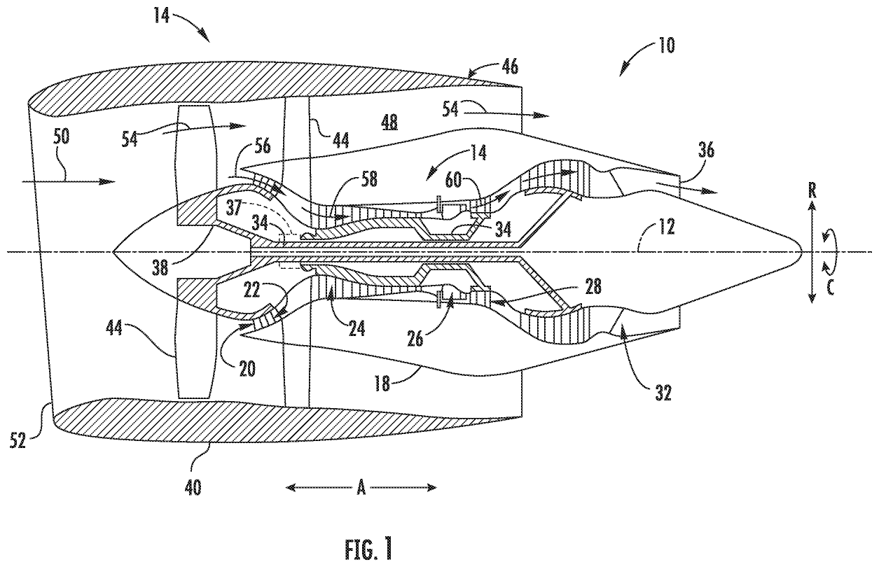

FIG. 1 provides a schematic cross-sectional view of one embodiment of a gas turbine engine 10 that may be utilized within an aircraft in accordance with aspects of the present subject matter. As shown, the engine 10 has a longitudinal or axial centerline axis 12 extending therethrough for reference purposes. Moreover, the gas turbine engine 10 defines an axial direction A, a radial direction R, and a circumferential direction C extending three hundred sixty degrees (360°) around the axial direction A.

In general, the engine 10 includes a core gas turbine engine 14 and a fan section 16 positioned upstream thereof. The core engine 14 includes a tubular outer casing 18 that defines an annular core inlet 20. In addition, the outer casing 18 may further enclose and support a booster compressor 22 for increasing the pressure of the air that enters the core engine 14 to a first pressure level. A high pressure, multi-stage, axial-flow compressor 24 may then receive the pressurized air from the booster compressor 22 and further increase the pressure of such air. The pressurized air exiting the high-pressure compressor 24 may then flow to a combustor 26 within which fuel is injected into the flow of pressurized air, with the resulting mixture being combusted within the combustor 26. The high energy combustion products are directed from the combustor 26 along the hot gas path of the engine 10 to a first (high pressure, HP) turbine 28 for driving the high pressure compressor 24 via a first (high pressure, HP) drive shaft 30, and then to a second (low pressure, LP) turbine 32 for driving the booster compressor 22 and fan section 16 via a second (low pressure, LP) drive shaft 34 that is generally coaxial with first drive shaft 30. After driving each of turbines 28 and 32, the combustion products may be expelled from the core engine 14 via an exhaust nozzle 36 to provide propulsive thrust.

Each turbine 28, 30 may generally include one or more turbine stages, with each stage including a turbine nozzle and a downstream turbine rotor blade. The turbine nozzle may include a plurality of vanes disposed in an annular array about the centerline axis 12 of the engine 10 for turning or otherwise directing the flow of combustion products through the turbine stage towards a corresponding annular array of rotor blades forming part of the turbine rotor. As is generally understood, the rotor blades may be coupled to a rotor disk of the turbine rotor, which is, in turn, rotationally coupled to the turbine's drive shaft (e.g., drive shaft 30 or 34).

Additionally, as shown in FIG. 1, the fan section 16 of the engine 10 includes a rotatable, axial-flow fan rotor 38 that is configured to be surrounded by an annular fan casing 40 or nacelle. In some embodiments, the (LP) drive shaft 34 may be connected directly to the fan rotor 38 such as in a direct-drive configuration. In alternative configurations, the (LP) drive shaft 34 may be connected to the fan rotor 38 via a speed reduction device 37, such as a reduction gear gearbox in an indirect-drive or geared-drive configuration. Such speed reduction devices may be included between any suitable shafts/spools within engine 10 as desired or required.

The fan casing 40 is supported relative to the core engine 14 by a plurality of substantially radially-extending, circumferentially-spaced outlet guide vanes 42. As such, the fan casing 40 may enclose the fan rotor 38 and its corresponding fan rotor blades 44. Moreover, a downstream section 46 of the fan casing 40 may extend over an outer portion of the core engine 14 so as to define a secondary, or by-pass, airflow conduit 48 that provides additional propulsive jet thrust.

During operation of the engine 10, an initial air flow (indicated by arrow 50) may enter the engine 10 through an associated inlet 52 of the fan casing 40. The air flow 50 then passes through or across the fan blades 44 and splits into a first compressed air flow (indicated by arrow 54) that moves through by-pass conduit 48 and a second compressed air flow (indicated by arrow 56) which enters the booster compressor 22 through core annular inlet 20. The pressure of the second compressed air flow 56 is then increased and enters the high pressure compressor 24 (as indicated by arrow 58). After mixing with fuel and being combusted within the combustor 26, the combustion products 60 exit the combustor 26 and flow through the HP or first turbine 28. Thereafter, the combustion products 60 flow through the LP or second turbine 32 and exit the exhaust nozzle 36 to provide thrust for the engine 10.

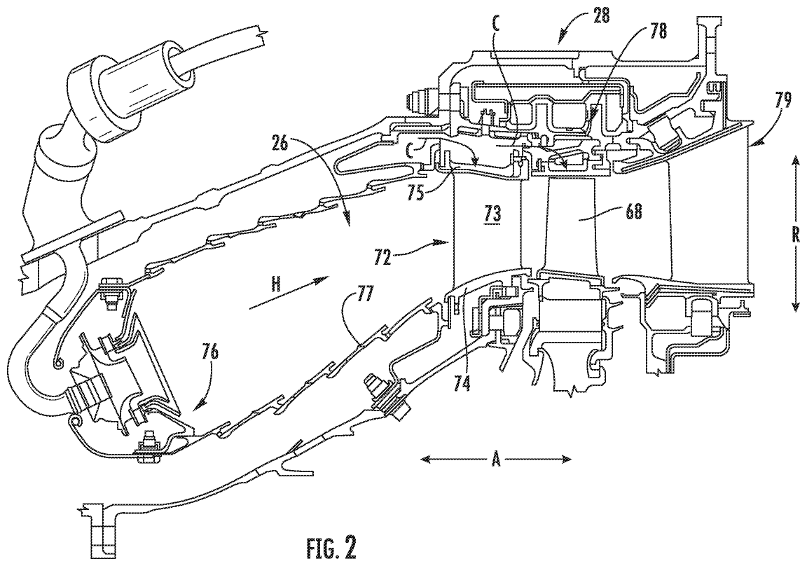

FIG. 2 provides a side section view of the combustor 26 and first turbine 28 (i.e., the HP turbine) of the engine 10 of FIG. 1. The combustor 26 includes a deflector 76 and a combustor liner 77 that has an inner wall and an outer wall spaced radially outward of the inner wall. The HP turbine 28 is directly downstream of the combustor 26. The HP turbine 28 includes a first stage having an annular array of nozzles 72 and an array of turbine blades 68 axially spaced from the nozzles 72. Each nozzle 72 (only one shown in FIG. 2) includes one or more static airfoils or vanes 73 that extend radially between an inner band 74 and an outer band 75. The vanes 73 are circumferentially spaced from one another. The nozzles 72 facilitate the flow of combustion gasses into the downstream rotating blades 68 so that the maximum energy may be extracted by the turbine 28. A shroud assembly 78 is adjacent to the rotating blades 68 to minimize flow loss in the turbine 28. The shroud assembly 78 is radially spaced from the blade tips of the turbine blades 68 and may include a plurality of shroud segments. The shroud segments may be coupled with a turbine casing, e.g., via shroud hangers. Further, the HP turbine 28 may include other stages. For instance, in FIG. 2, an annular array of nozzles 79 is positioned downstream of turbine blades 68. The nozzles 79 may be similarly configured as the nozzles 72.

In some embodiments, a cooling fluid CF (e.g., compressor discharge air) may be directed to cool one or more components of the HP turbine 28 as hot combustion gasses H flow along the hot gas path of the engine 10. For instance, in the depicted embodiment of FIG. 2, a cooling fluid CF is directed to cool one of the outer bands 75 of the nozzles 72 and one of the shroud segments of the shroud assembly 78. Other components of the HP turbine 28, the LP turbine 32, the LP or booster compressor 22, or the HP compressor 24 may be similarly cooled by a cooling fluid CF. One or more engine components of the engine 10 (FIG. 1) may include one or more cooling features or passages, e.g., to facilitate film cooling of the component. Some non-limiting examples of the engine component having a feature that facilitates film-cooling can include the blades 68, components of nozzles 72, combustor deflector 76, combustor liner 77, and/or components of shroud assembly 78, described in FIGS. 1-2. Other non-limiting examples where film cooling is used include turbine transition ducts and exhaust nozzles.

In addition, in some embodiments, components of turbofan engine 10 having one or more cooling features may be formed of a ceramic matrix composite (CMC) material, particularly components within the hot gas path. CMC materials are non-metallic and have a high temperature capability. Exemplary CMC materials utilized for such components may include silicon carbide, silicon, silica, or alumina matrix materials and combinations thereof. Ceramic fibers may be embedded within the matrix, such as oxidation stable reinforcing fibers including monofilaments like sapphire and silicon carbide (e.g., Textron's SCS-6), as well as rovings and yarn including silicon carbide (e.g., Nippon Carbon's NICALON®, Ube Industries' TYRANNO®, and Dow Corning's SYLRAIVIIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). As further examples, the CMC materials may also include silicon carbide (SiC) or carbon fiber cloth. CMC materials may be used for various components of the engine, for example, airfoils in the turbine, compressor, and/or fan regions, as well as shrouds, liners, or other components of the engine. Example components (e.g., CMC components) having one or more cooling features and methods for forming such components are provided below.

FIG. 3 provides a flow diagram depicting one example manner in which a laminate component may be formed or manufactured. More particularly, FIG. 3 provides a flow diagram of an exemplary method (300) for forming a laminate component, such as a laminate CMC component for a gas turbine engine. For instance, the laminate CMC component formed by method (300) may be employed with the gas turbine engine 10 of FIGS. 1 and 2. In addition, FIG. 3 depicts steps performed in a particular order for purposes of illustration and discussion. Those of ordinary skill in the art, using the disclosures provided herein, will understand that the various steps of any of the methods disclosed herein can be modified, adapted, expanded, rearranged and/or omitted in various ways without deviating from the scope of the present disclosure.

At (302), the method (300) includes forming a plurality of plies derived from a plurality of prepreg tapes. For instance, for fabrication of a CMC laminate component, each prepreg tape can include the desired ceramic fiber reinforcement material, one or more precursors of the CMC matrix material, and organic resin binders. The prepreg tapes can be formed by impregnating the reinforcement material with a slurry that contains a ceramic precursor(s) and binders. Materials selected for the precursor will depend on the particular composition desired for the ceramic matrix of the CMC component, for example, SiC powder and/or one or more carbon-containing materials if the desired matrix material is SiC. Notable carbon-containing materials include carbon black, phenolic resins, and furanic resins, including furfuryl alcohol (C₄H₃OCH₂OH). Other typical slurry ingredients include organic binders (for example, polyvinyl butyral (PVB)) that promote the flexibility of prepreg tapes, and solvents for the binders (for example, toluene and/or methyl isobutyl ketone (MIBK)) that promote the fluidity of the slurry to enable impregnation of the fiber reinforcement material. The slurry may further contain one or more particulate fillers intended to be present in the ceramic matrix of the CMC laminate component, for example, silicon and/or SiC powders in the case of a Si—SiC matrix. The slurry composition can be applied directly to a continuous strand of tow as the tow is wound onto a drum; as such, the resultant tape is wound onto the drum. The prepreg tapes may be cut from the drum, dried, and cut to shape to form CMC plies. As noted below, the CMC plies may then be laid up to form one or more laminates.

At (304), the method (300) includes laying up the one or more plies, e.g., to form a preform having the desired shape or contour of the final CMC laminate component. For instance, plies derived from the prepreg tapes may be laid up on a layup tool, mandrel, mold, or other appropriate device for supporting the plies and/or for defining the final desired shape. The plies may be laid up manually, utilizing an automatic lay up device, or in some other suitable fashion. In some implementations, a plurality of plies can be laid up to form a preform having the desired final shape. In some implementations, the plies can be laid up into laminate sections that may then be laid up together to form the preform.

At (306), the method (300) includes curing the preform to form a green state component. For instance, curing can include debulking and/or compacting the preform to form the green state component. As one example, the preform can be vacuum bagged and debulked/compacted at elevated temperature and pressure in an autoclave. The preform can be subject to typical pressures and temperature cycles used in the industry for CMC materials. As one example, the debulking temperature can be set below the decomposition temperature of the binder and plasticizer of the slurry composition of the tapes from which the plies are made. After curing, as noted above, the preform becomes a green state component.

At (308), the method (300) includes firing or burning out the green state component. For instance, the green state component may can be placed in a furnace to burn off any mandrel-forming materials and/or solvents used in forming the CMC plies, to decompose binders in the solvents, and to convert a ceramic matrix precursor of the plies into the ceramic material of the matrix of the CMC laminate component. Due to decomposition of the binders, the result is a porous CMC body. Accordingly, as will be explained more fully below, the CMC body or burned out component may undergo an infiltration process to densify the component to yield the CMC component.

At (310), the method (300) includes infiltrating the laminate component with an infiltration material. For instance, infiltrating the laminate component may be achieved by various processes, including melt infiltration (MI) and chemical vapor infiltration (CVI). In some implementations, the infiltration material is silicon. Infiltrating the laminate component with the infiltration material fills the porosity of the burned out component and thus densifies the component. In some example implementations, the laminate component may be placed in a furnace with a piece or slab of silicon. The furnace is then fired to melt infiltrate the component with silicon or another suitable infiltration material. The infiltrated CMC component hardens to form the final CMC component. Specific processing techniques and parameters for the above process will depend on the particular composition of the materials.

At (312), optionally, the method (300) includes finish machining the CMC component as desired or as needed. For instance, various features may be machined into the CMC component, e.g., by electrical discharge machining (EDM) or some other machining technique. As one example, a plurality of cooling holes may be machined into the CMC component via EDM.

In some implementations of method (300), the CMC component may be laser cut or machined by a laser device. In accordance with exemplary aspects of the present disclosure, one or more features may be laser cut into the CMC component at one or more stages of the fabrication process, e.g., to form a cooling circuit therein. Particularly, one or more features may be laser cut or machined into or along one or more laminate sections, individual plies, and/or the preform while exposed to an atmosphere (i.e., not in a vacuum). For example, in some implementations, the atmosphere can be air. As a by-product of the laser cutting operation, oxide layers are formed on the laser cut surfaces. As one example, a silicon oxide layer may be formed on each laser cut surface of the machined feature. The oxide layers resulting from this machining operation prevent an infiltration material (e.g., silicon) from wicking and filling the passages during infiltration at (310). As will be explained further herein, features may be laser cut into or along adjacent laminate sections or plies to introduce local turbulator features, wetted surface area nubs, locating features, etc. Moreover, laser cuts can be made to vent the passages during autoclave and burnout, and to route supply air. Laser cuts can be staggered radially or offset axially to prevent infiltration shadowing. Moreover, surface ablation can also be implemented on the interfacing faces of laminate sections.

As shown in FIG. 3, in some implementations, features may be laser cut into or along plies derived from the prepreg tapes at (314A), e.g., after the plies are derived from the prepreg tapes at (302). In some implementations, additionally or alternatively to (314A), features may be laser cut into or along laminate sections or the preform at (314B), e.g., after layup of one or more plies at (304). In yet other implementations, additionally or alternatively to (314A) and (314B), features may be laser cut into or along the green state component after curing at (314C), e.g., after curing at (306). Exemplary CMC components formed by method (300) are provided below.

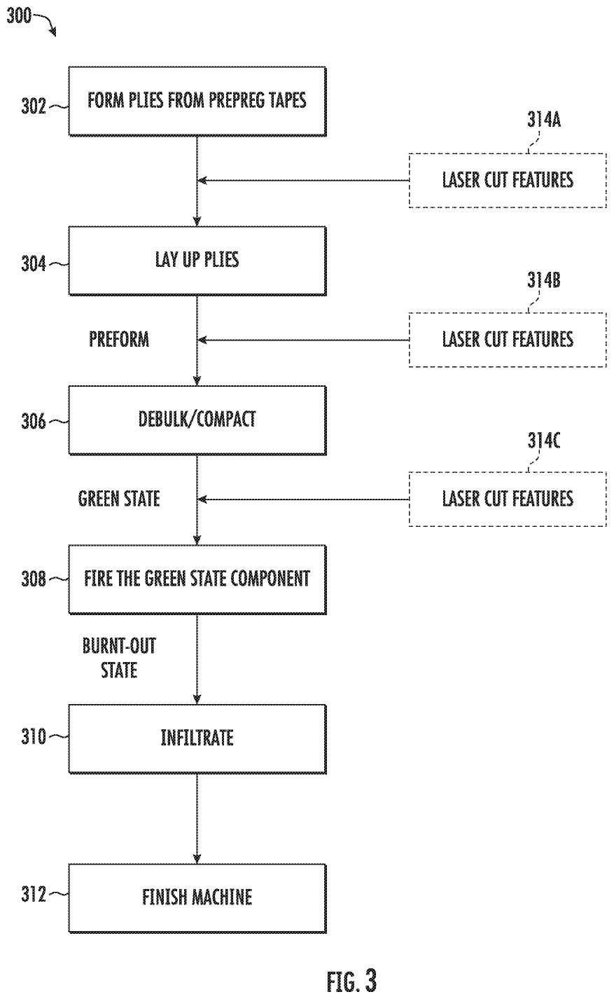

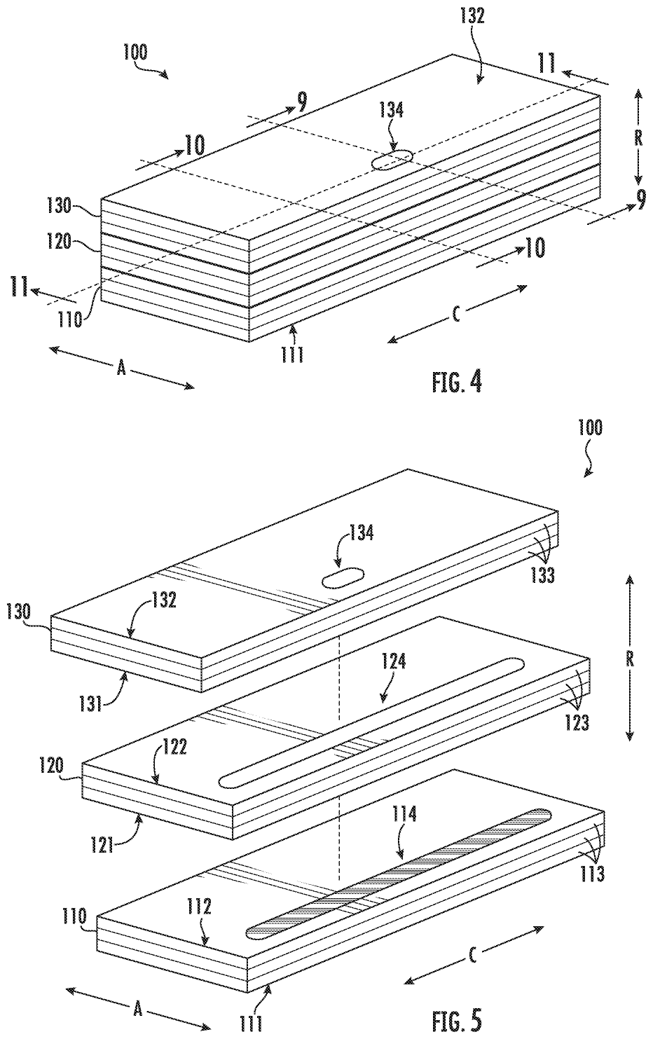

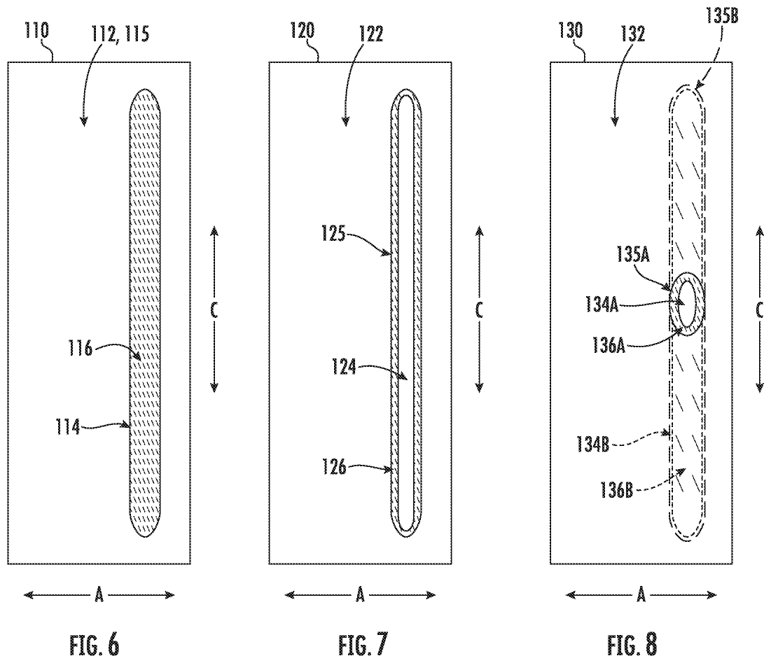

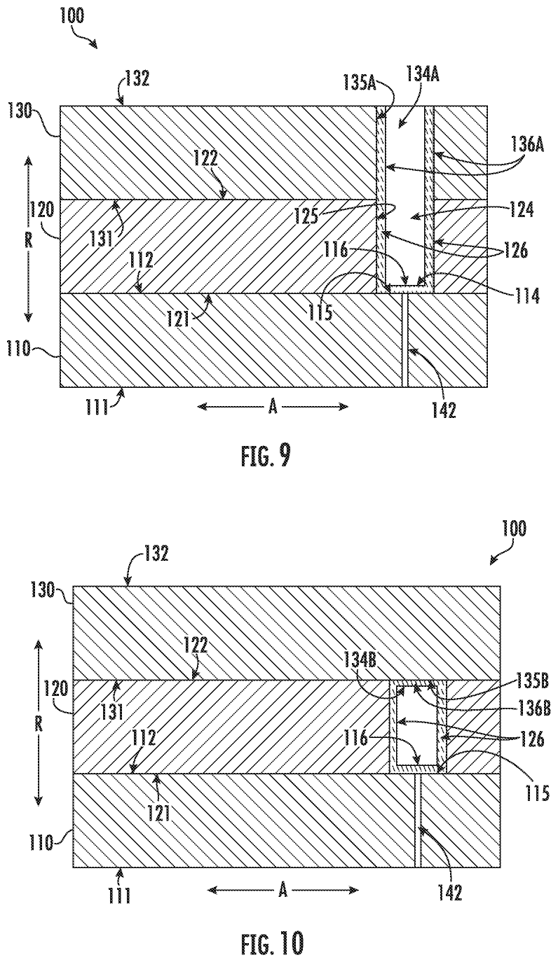

With reference now to FIGS. 4 through 11, various views of an example laminate component 100 are provided according to one embodiment of the present disclosure. In particular, FIG. 4 provides a perspective view of the laminate component 100. FIG. 5 provides an exploded view of the laminate component 100 of FIG. 4. FIGS. 6, 7, and 8 provide top plan views of a first laminate section 110, a second laminate section 120, and a third laminate section 130 of the laminate component 100 of FIG. 4, respectively. FIG. 9 provides a cross-sectional view of the laminate component 100 of FIG. 4 taken along line 9-9 of FIG. 4. FIG. 10 provides a cross-sectional view of the laminate component 100 of FIG. 4 taken along line 10-10 of FIG. 4. FIG. 11 provides a cross-sectional view of the laminate component 100 of FIG. 4 taken along line 11-11 of FIG. 4. The laminate component 100 may be formed via method (300) described above, for example. As one example, the laminate component 100 can be a flowpath component of a gas turbine engine, such as a shroud of the shroud assembly 78 or an outer or inner band 75, 74 of one of the nozzles 72 of FIG. 2.

As shown, the laminate component 100 defines an axial direction A, a radial direction R, and a circumferential direction C extending three hundred sixty degrees (360°) around the axial direction A. For this embodiment, the laminate component 100 has three (3) laminate sections, e.g., that may be formed as described at (304) of method (300). Specifically, the laminate component 100 has a first laminate section 110, a second laminate section 120, and a third laminate section 130. The second laminate section 120 is disposed between the first laminate section 110 and the third laminate section 130, e.g., along the radial direction R. In alternative embodiments, the laminate component 100 may have more or less than three (3) laminate sections. Each laminate section 110, 120, 130 is formed of one or more plies. As shown best in FIG. 5, the first laminate section 110 includes one or more plies 113, the second laminate section 120 includes one or more plies 123, and the third laminate section 130 includes one or more plies 133. For the depicted embodiment, the first laminate section 110, the second laminate section 120, and the third laminate section 130 each include three (3) plies. The plies 113, 123, 133 may be formed of a CMC material, e.g., a SiC/SiC material, and may be derived from CMC prepreg tapes as described above at (302) of method (300).

As shown best in FIGS. 5, 6, 9, and 10, the first laminate section 110 has a first side 111 and a second side 112 spaced from the first side 111, e.g., along the radial direction R. Notably, the first laminate section 110 is laser cut (e.g., at (314B) of method (300)) to define one or more features 114 each having one or more surfaces 115. When the first laminate section 110 is laser cut, an oxide layer 116 is formed on each surface 115 of the features 114. For this embodiment, the feature 114 defined by the first laminate section 110 is a surface ablation laser cut along the second side 112 of the first laminate section 110. Thus, the surface 115 of the feature 114 is the outer surface of the first laminate section 110 at the second side 112.

As shown best in FIGS. 5, 7, 9, and 10, the second laminate section 120 has a first side 121 and a second side 122 spaced from the first side 121, e.g., along the radial direction R. Like the first laminate section 110, the second laminate section 120 is laser cut (e.g., at (314B) of method (300)) to define one or more features 124 each having one or more surfaces 125. When the second laminate section 120 is laser cut, an oxide layer 126 is formed on each surface 125 of the features 124. For this embodiment, the feature 124 defined by the second laminate section 120 is a channel laser cut to have a complementary shape to the surface ablation of the first laminate section 110. The channel has a depth extending between the first side 121 and the second side 122 of the second laminate section 120. In this manner, the channel extends radially through the thickness of the second laminate section 120. As best shown in FIGS. 9 and 10, when the first and second laminate sections 110, 120 are laid up to form at least a portion of the laminate component 100, the feature 124 of the second laminate section 120 is in communication with the feature 114 of the first laminate section 110. More particularly, the channel of the second laminate section 120 is aligned with the surface ablation of the first laminate section 110.

As shown best in FIGS. 4, 5, 8, 9, and 10, the third laminate section 130 has a first side 131 and a second side 132 spaced from the first side 131, e.g., along the radial direction R. Like the first laminate section 110 and the second laminate section 120, the third laminate section 130 is laser cut (e.g., at (314B) of method (300)) to define one or more features each having one or more surfaces. For this embodiment, two (2) features are laser cut into or along the third laminate section 130. Particularly, one feature 134A laser cut into third laminate section 120 is a through hole. The through hole has a depth extending between the first side 131 and the second side 132 of the third laminate section 130. In this manner, the through hole extends radially through the thickness of the third laminate section 130. When the through hole feature 134A is laser cut into the third laminate section 130, an oxide layer 136A is formed on each surface 135A of the feature 134A. Further, as best shown in FIGS. 10 and 11, another feature 134B laser cut into third laminate section 120 is a surface ablation formed along the outer surface of the third laminate section 130 at the first side 131. When the surface ablation feature 134B is laser cut into the third laminate section 130, an oxide layer 136B is formed on each surface 135B of the feature 134B.

As best shown in FIGS. 9 and 10, when the first, second, and third laminate sections 110, 120, 130 are laid up to form at least a portion of the laminate component 100, the feature 124 of the second laminate section 120 is in communication with the feature 114 of the first laminate section 110 as noted above, and the features 134A, 134B of the third laminate section 130 are in communication with the feature 124 of the second laminate section 120. More particularly, the channel of the second laminate section 120 is aligned with the surface ablation feature 134B of the third laminate section 130 and the through hole feature 134A is also aligned with the channel feature 124 of the second laminate section 120, e.g., as shown best in FIGS. 9 and 11.

As shown best in FIG. 11, the features 114, 124, 134A, and 134B defined by the first, second, and third laminate sections 110, 120, 130 collectively form a cavity 140. The surfaces of the features114, 124, 134A, and 134B that define the cavity 140 all have oxide layers 116, 126, 136A, 136B formed thereon, e.g., as a result of laser cutting. Stated differently, the boundary of the cavity 140 is entirely surrounded or enclosed by an oxide layer. Accordingly, during infiltrating (e.g., at (310) of method (300)), the oxide layers 116, 126, 136A, 136B formed on the one or more surfaces 115, 125, 135A, 135B that define the through hole and surface ablation of the first laminate component 110, the channel of the second laminate component 120, and the surface ablation of the third laminate section 130 prevent the infiltration material (e.g., silicon) from infiltrating (e.g., filling into wicking) into the cavity 140. Thus, after infiltrating, the cavity 140 of the laminate component 100 is absent the infiltration material or has some negligible amount. Accordingly, no items need be removed from the cavity and machining is reduced post-densification of the component 100, among other benefits.

As shown best in FIGS. 9, 10, and 11, after infiltrating the laminate component 100 with the infiltration material (e.g., at (310) of method (300)), the one or more cooling holes 142 can be machined into at least one of the first laminate section 110, the second laminate section 120, and the third laminate section 130 such that the cooling holes 142 extend from the cavity 140 to an outer surface of the laminate component 100, such as the second side 132 of the third laminate section 130 or the first side 111 of the first laminate section 110. For this embodiment, cooling holes 142 are machined through the radial thickness of the first laminate section 110. The cooling holes 142 extend between the cavity 140 and the first side 111 of the first laminate section 110. In some embodiments, particularly where the laminate component 100 is a flowpath component (e.g., a shroud of the shroud assembly 78 of FIG. 2), the cooling holes 142 in combination with the cavity 140 may define a cooling circuit 144. In such embodiments, a cooling fluid CF (e.g., compressor discharge air) may flow into the cavity 140 through the through hole feature 134A and into the channel feature 124. The cooling fluid CF may then flow downstream through the cooling holes 142 and into the hot gas path. The cooling fluid CF may remove heat from the laminate component 100.

FIG. 12 provides a schematic radial cross-sectional view of a laminate section 150 having a feature 152 laser cut therein according to an example embodiment of the present disclosure. For instance, the laminate section 150 may be the second laminate section 120 described herein and illustrated in the figures. As shown in FIG. 12, for this embodiment, the feature 152 laser cut into the laminate section 150 is defined having a channel 154 with one or more turbulators 156 projecting into the channel 154. The channel 154 can extend the radial thickness of the laminate section 150. The turbulators 156 project axially and circumferentially into the channel 154 from a forward wall 158 toward an aft wall 160 of the laminate section 150. The turbulators 156 each have a radial thickness and are circumferentially spaced from one another. The turbulators 156 are angled with respect to the axial direction A. Notably, when the turbulators 156 are laser cut, e.g., by a suitable laser device, an oxide layer 162 is formed on each surface 164 of the turbulators 156. In this way, infiltration material (e.g., silicon) is prevented from infiltrating (e.g., filling or wicking) into the channel 154 (e.g., at (310) of method (300)). In some alternative embodiments, the turbulators 156 may have other suitable shapes. Further, in some embodiments, additionally or alternatively, other features may be laser cut into or along adjacent laminate sections or plies to introduce wetted surface area nubs, locating features, etc.

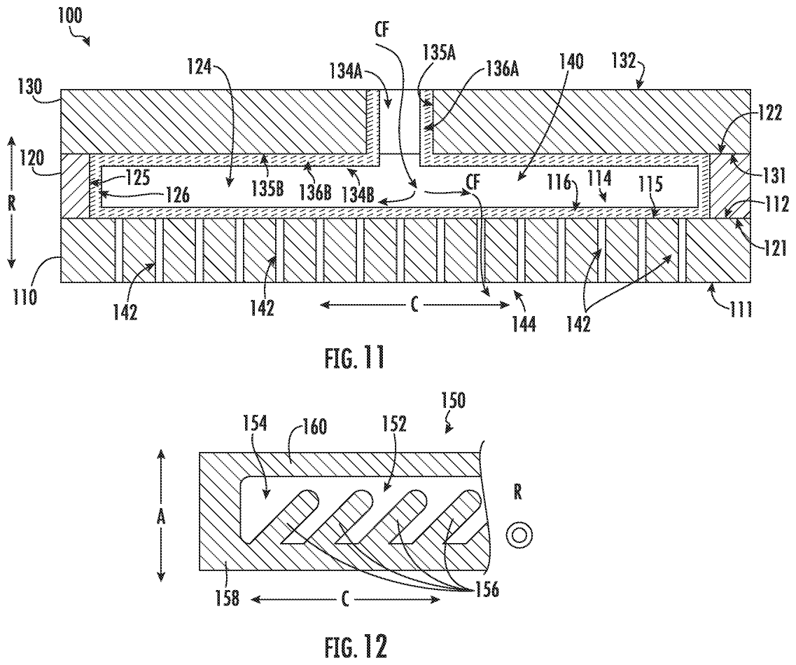

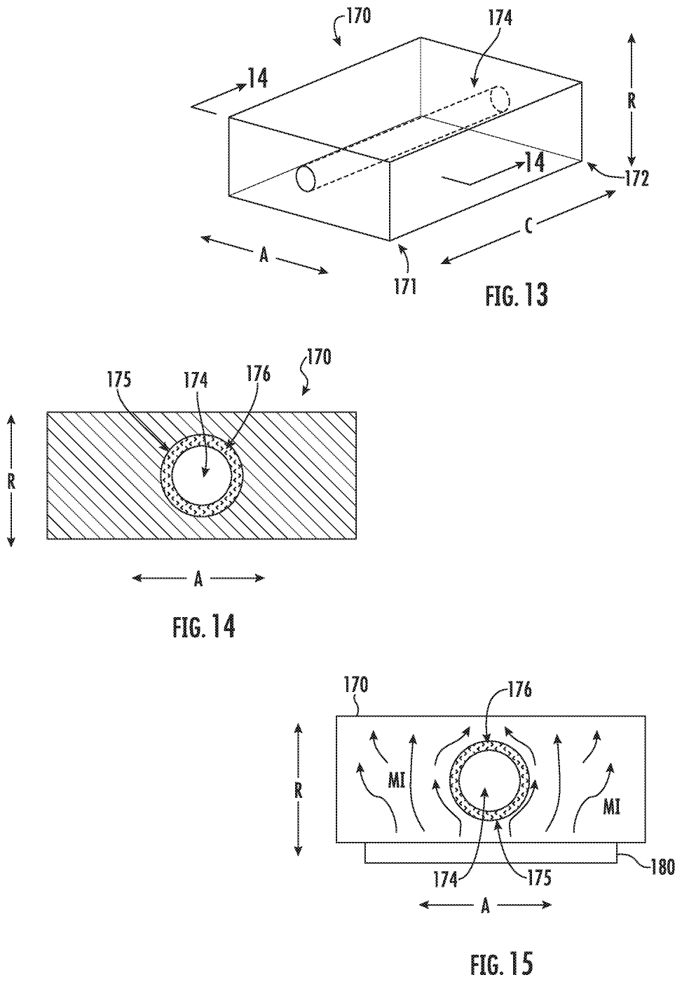

FIGS. 13, 14, 15 provide various views of an example laminate section 170 of a laminate component according to an example embodiment of the present disclosure. In particular, FIG. 13 provides a perspective view of the laminate section 170 having a laser cut feature, FIG. 14 provides a cross-sectional view of the laminate section 170 of FIG. 13 taken along line 14-14 of FIG. 13, and FIG. 15 provides a schematic view of the laminate section 170 and depicts the laminate section 170 in the process of being infiltrated with an infiltration material. The laminate section 170 (or laminate component that the laminate section 170 forms at least a portion of) may be formed in accordance with method (300), for example.

As shown, the laminate section 170 formed of one or more plies (e.g., one or more CMC plies) has been laser cut to define a feature 174 having one or more surfaces 175. More particularly, for this embodiment, the feature 174 laser cut into the laminate section 170 is a through hole that extends between a first end 171 and a second end 172 of the laminate section 170. When the feature 174 is laser cut into the laminate section 170, an oxide layer 176 is formed or created on the surfaces 175 that define feature 174. The oxide layer 176 can be a silicon oxide layer, for example.

In accordance with exemplary aspects of the present disclosure, the feature 174 is laser cut prior to infiltrating the laminate section 170 with an infiltration material (e.g., at (310) of method (300)). In this way, when the laminate section 170 is infiltrated with the infiltration material, the oxide layer 176 formed on the one or more surfaces 175 of the feature 174 prevents the infiltration material from infiltrating therethrough. As shown in FIG. 15, a block of infiltration material 180 (e.g., silicon) is infiltrated into the laminate section 170. As the infiltration material 180 is infiltrated into the laminate section 170 (denoted by the arrows labeled “MI”), the oxide layer 176 provides a boundary around the feature 174 and prevents the infiltration material 180 from filling or wicking into the through hole feature 174 defined by laminate section 170. Consequently, the infiltrated laminate section 170 requires no or minimal machining to create the through hole feature 172.

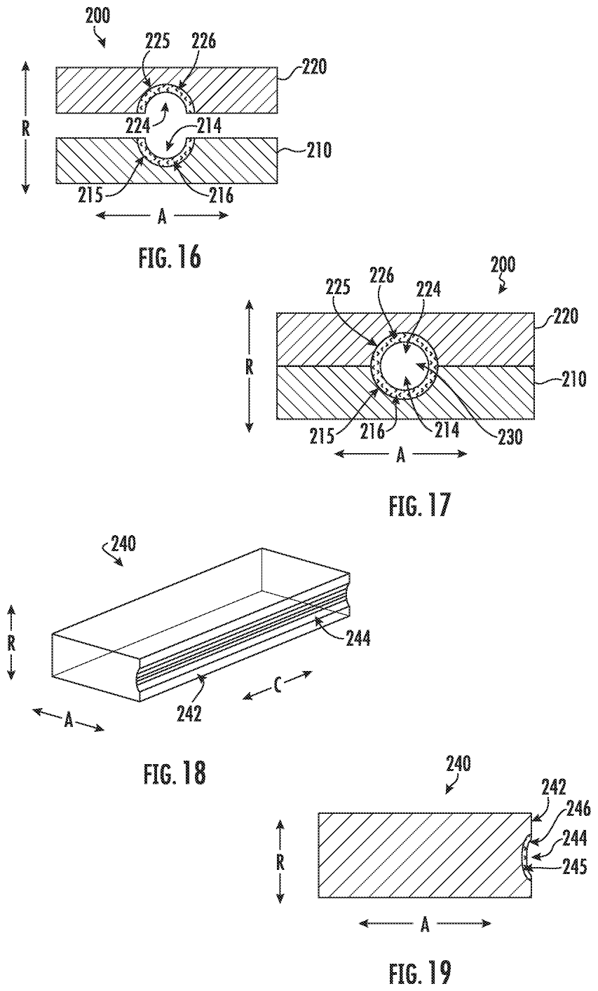

FIGS. 16 and 17 provide various views of an exemplary laminate component 200 according to an example embodiment of the present disclosure. In particular, FIG. 16 provides a section view of a second laminate section 220 having a laser cut feature 224 being laid up on a first laminate section 210 having a laser cut feature 214 to form the laminate component 200. FIG. 17 provides a cross-sectional view of the laminate component 200. The laminate component 200 may be formed in accordance with method (300), for example.

As shown, the first laminate section 210 formed of one or more plies (e.g., one or more CMC plies derived from prepreg tapes) of the laminate component 200 has been laser cut to define a feature 214 having one or more surfaces 215. When the feature 214 is laser cut into the first laminate section 210, an oxide layer 216 is formed or created on the surfaces 215 that define feature 214. The oxide layer 216 can be a silicon oxide layer, for example. Likewise, the second laminate section 220 formed of one or more plies (e.g., one or more CMC plies derived from prepreg tapes) of the laminate component 200 has been laser cut to define a feature 224 having one or more surfaces 225. When the feature 224 is laser cut into the second laminate section 220, an oxide layer 226 is formed or created on the surfaces 225 that define feature 224. The oxide layer 226 can be a silicon oxide layer, for example.

Moreover, as depicted, the second laminate section 220 is laid up so that the second laminate section 220 and the first laminate section 210 form at least a portion of the laminate component 200. In addition, the second laminate section 220 is laid up with or on the first laminate section 210 so that the feature 224 of the second laminate section 220 is positioned in communication with the feature 214 of the first laminate section 210. For instance, for this embodiment, the laminate sections 210, 220 are positioned relative to one another so that the feature 214 of the first laminate section 210 and the feature 224 of the second laminate section 220 are aligned in communication so that the features 214, 224 form a cylindrical cavity 230. Further, as shown, the features 214, 224 are laser cut and aligned in communication so that cavity 230 is entirely enclosed or encased by the oxide layers 216, 218 formed on the surfaces 215, 225 of the features 214, 224.

In accordance with exemplary aspects of the present disclosure, the features 214, 224 are laser cut prior to infiltrating the laminate component 200 with an infiltration material (e.g., at (310) of method (300)). For example, the laminate sections 210, 220 of the laminate component 200 may be laser cut at (314A), (314B), and/or at (314C) of method (300), for example. Accordingly, when the laminate component 200 is infiltrated with the infiltration material, the oxide layers 216, 226 formed on the one or more surfaces 215, 225 of the features 214, 224 provide a boundary around the cavity 230 and prevent the infiltration material from infiltrating therethrough, or in this embodiment, into the cavity 230 collectively defined by the features 214, 224.

FIGS. 18 and 19 provide various views of an example laminate section 240 of a laminate component according to an example embodiment of the present disclosure. In particular, FIG. 18 provides a perspective view of a laminate section 240 having a laser cut feature 244 and FIG. 19 provides a cross-sectional view thereof. The laminate section 240 (or laminate component that the laminate section 240 forms at least a portion of) may be formed in accordance with method (300), for example.

As shown, in some embodiments, one or more features can be laser cut (e.g., prior to infiltration) along an outer surface of a laminate section of a laminate component. The laminate section 240 may be a single ply or a plurality of plies (e.g., CMC plies). For instance, as depicted in FIGS. 18 and 19, the feature 244 has been laser cut along an external surface 242 (i.e., a surface exposed to an environment) of the laminate section 240. When the feature 244 is laser cut, an oxide layer 246 is formed on the one or more surfaces 245 defining the feature 244. For this embodiment, the feature 244 is an arcuate cutout laser cut along a sidewall of the laminate section 240.

In accordance with exemplary aspects of the present disclosure, the feature 244 is laser cut prior to infiltrating the laminate section 240 (or the laminate component that the laminate section 240 forms at least a portion of) with an infiltration material (e.g., at (310) of method (300)). For example, the laminate section 240 may be laser cut at (314A), (314B), and/or at (314C) of method (300), for example. Thus, when the laminate section 240 is infiltrated with the infiltration material, the oxide layer 246 formed on the one or more surfaces 245 of the feature 244 provides a boundary or a stop that prevents the infiltration material from infiltrating therethrough. As a result, a more smooth outer surface may be achieved along the laser cut feature 244 of the laminate section 240 and thus no or minimal machining is necessary to finish machine the surfaces 245 that define the feature 244 (e.g., at (312) of method (300)). Further, in some embodiments, the laminate section 240 may be laid up with a second laminate section (not shown) so that the feature 244 of the laminate section 240 is in communication with a feature laser cut into the second laminate section, e.g., in a similar manner as described above with regard to the embodiment of FIGS. 16 and 17.

FIGS. 20 through 27 provide various view of other example laminate sections and/or laminate components that have one or more laser cut features along one or more external or outer surfaces thereof

FIG. 20 provides a perspective view of an example laminate section 250 formed of a plurality of plies 252 stacked or laid up along a stack direction S. As shown, for this embodiment, the laminate section 250 has a laser cut feature 254 that is laser cut along a cut-edge surface 256 that extends in a plane orthogonal (or substantially orthogonal) to the stack direction S of the plies 252. Notably, the cut-edge surface 256 can be laser cut such that an oxide layer 258 is formed thereon. For instance, a through-ply edge laser cutting technique can be used to form the cut-edge surface 256 and oxide layer 258 simultaneously. External oxide layers of this type can reduce follow-on finish machining by reducing machining stock to be removed.

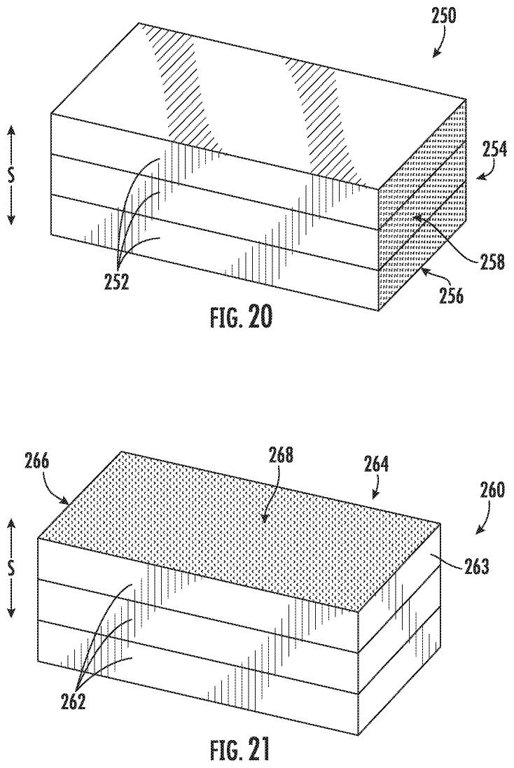

FIG. 21 provides a perspective view of another example laminate section 260 formed of a plurality of plies 262 stacked or laid up along a stack direction S. As depicted, for this embodiment, the laminate section 260 has a laser cut feature 264 that is laser cut along a surface 266 of a first ply 263 that extends in a plane parallel (or substantially parallel) to the stack direction S of the plies 262. Accordingly, for this embodiment, the laser cut feature on surface 266 of first ply 263 is a surface ablation. When the surface 266 is ablated via laser energy, an oxide layer 268 is formed thereon. The oxide layer 268 formed in the plane of the individual plies 262 (or orthogonal to the stack direction S) can control silicon fill (e.g., during infiltration at (310)) in the direction of the laminate stack direction S, among other benefits.

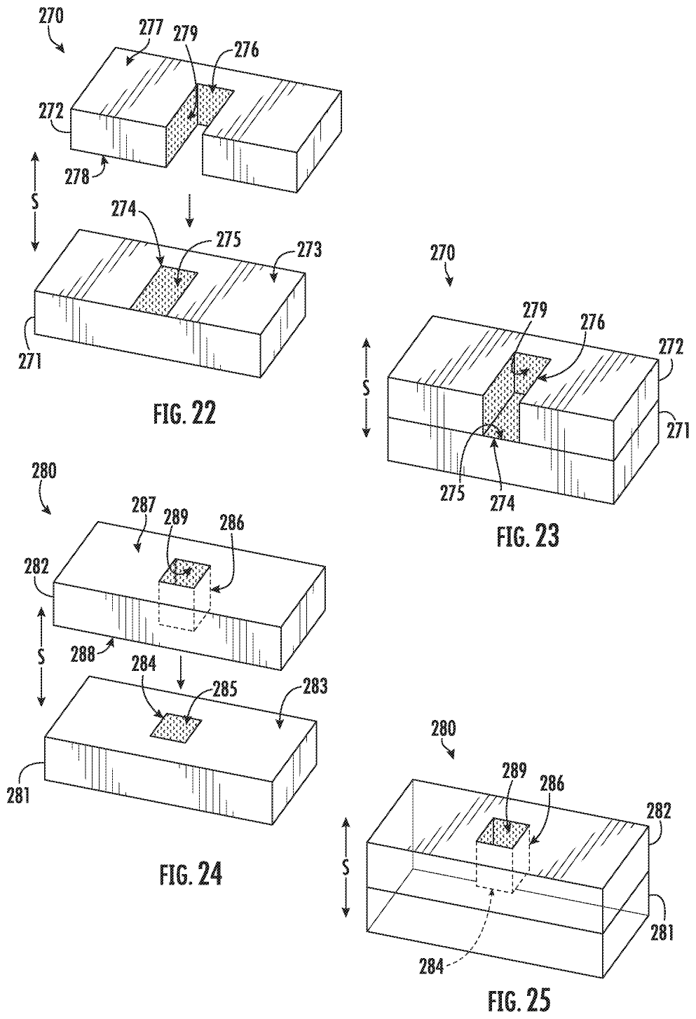

FIGS. 22 and 23 provide views of an example laminate component 270 formed by laying up a first laminate section 271 and a second laminate section 272. FIG. 22 provides a perspective exploded view of the first and second laminate sections 271, 272 in the process of being laid up and FIG. 23 provides a perspective view of the first and second laminate sections 271, 272 laid up. As depicted, the first laminate section 271 has a top external surface 273. Notably, the top external surface 273 has a laser cut feature 274, which is a surface ablation. An oxide layer 275 is formed on the ablated portion of the top surface 273 of the first laminate section 271. Further, the second laminate section 272 also has a laser cut feature 276, which is a cutout that extends from the top surface 277 of the second laminate section 272 to the bottom surface 278. Each of the external surfaces defining the cutout have an oxide layer 279 formed thereon.

As shown in FIG. 23, when the second laminate section 272 and the first laminate section 271 are laid up, the laser cut feature 274 of the first laminate section 271 and the laser cut feature 276 of the second laminate section 272 are positioned in communication with one another. The laser cut feature 274 of the first laminate section 271 can be used as a locating feature for laying up the second laminate section 272, or vice versa. When the first and second laminate sections 271, 272 are laid up, each external surface forming the cutout feature of laminate component 270 has an oxide layer formed thereon.

FIGS. 24 and 25 provide views of another example laminate component 280 formed by laying up a first laminate section 281 and a second laminate section 282. FIG. 24 provides a perspective exploded view of the first and second laminate sections 281, 282 in the process of being laid up and FIG. 25 provides a perspective view of the first and second laminate sections 281, 282 laid up. As depicted, the first laminate section 281 has a top external surface 283. Notably, the top external surface 283 has a laser cut feature 284, which is a surface ablation. An oxide layer 285 is formed on the ablated portion of the top surface 283 of the first laminate section 281. Further, the second laminate section 282 also has a laser cut feature 286, which is a rectangular shaped through hole that extends from the top surface 287 of the second laminate section 282 to the bottom surface 288. Each of the surfaces defining the through hole have an oxide layer 289 formed thereon.

As shown particularly in FIG. 25, when the second laminate section 282 and the first laminate section 281 are laid up, the laser cut feature 284 of the first laminate section 281 and the laser cut feature 286 of the second laminate section 282 are positioned in communication with one another. The laser cut feature 284 of the first laminate section 281 can be used as a locating feature for laying up the second laminate section 282, or vice versa. When the first and second laminate sections 281, 282 are laid up, each external surface forming the blind hole feature of laminate component 280 has an oxide layer formed thereon.

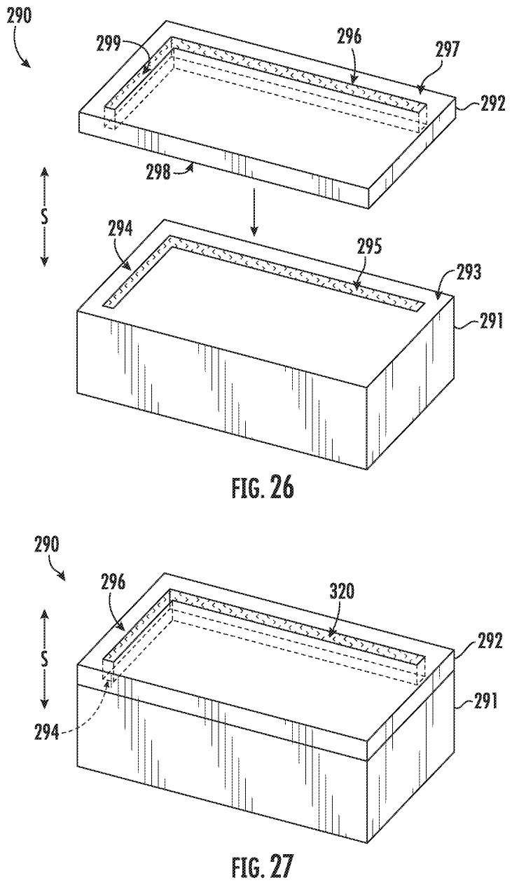

FIGS. 26 and 27 provide views of another example laminate component 290 formed by laying up a first laminate section 291 and a second laminate section 292. FIG. 26 provides a perspective exploded view of the first and second laminate sections 291, 292 in the process of being laid up and FIG. 27 provides a perspective view of the first and second laminate sections 291, 292 laid up. As depicted, the first laminate section 291 has a top external surface 293. Notably, the top external surface 293 has a laser cut feature 294, which is a surface ablation formed in the shape of an “L”. An oxide layer 295 is formed on the ablated portion of the top surface 293 of the first laminate section 291. Further, the second laminate section 292 also has a laser cut feature 296, which is an L-shaped through hole that extends from the top surface 297 of the second laminate section 292 to the bottom surface 298. Each of the surfaces defining the L-shaped through hole have an oxide layer 299 formed thereon. Notably, the thickness of the laminates along the stack direction S are selected in accordance with the desired depth of a perimeter guide 320 formed when the first and second laminate sections 291, 292 are laid up as shown in FIG. 27.

Particularly, as shown in FIG. 27, when the second laminate section 292 and the first laminate section 291 are laid up, the laser cut feature 294 of the first laminate section 291 and the laser cut feature 296 of the second laminate section 292 are positioned in communication with one another. The laser cut feature 294 of the first laminate section 291 can be used as a locating feature for laying up the second laminate section 292, or vice versa. When the first and second laminate sections 291, 292 are laid up, each external surface forming the perimeter guide 320 of laminate component 290 has an oxide layer formed thereon. Perimeter guides, such as perimeter guide 320 of FIG. 27, can be formed to control surface geometry supporting post-MI coating, particularly at the perimeter of the laminate component.

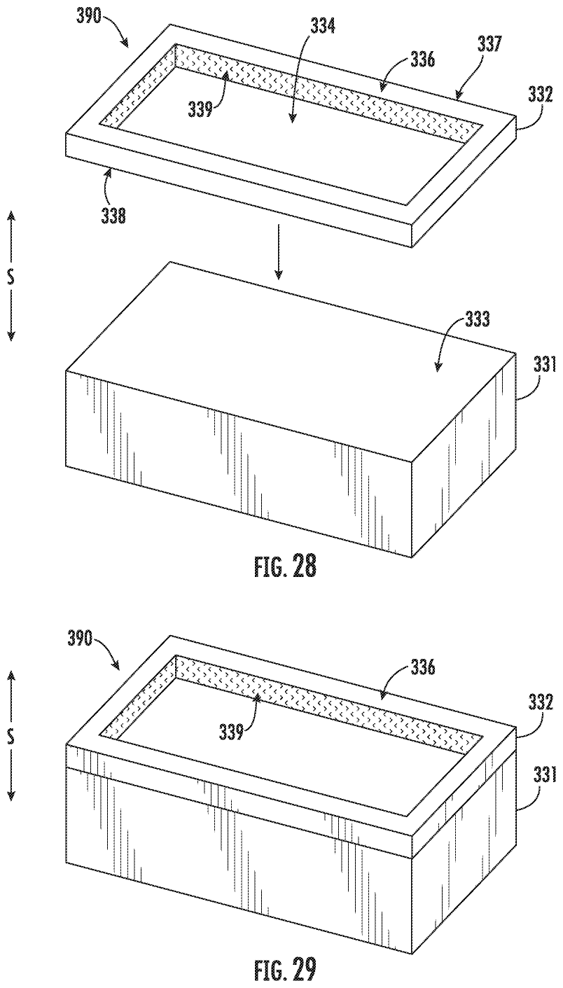

FIGS. 28 and 29 provide views of another example laminate component 390 formed by laying up a first laminate section 331 and a second laminate section 332. FIG. 28 provides a perspective exploded view of the first and second laminate sections 331, 332 in the process of being laid up and FIG. 29 provides a perspective view of the first and second laminate sections 331, 332 laid up. As depicted, the first laminate section 331 has a top external surface 333. For this embodiment, the top external surface 333 does not have a laser cut feature. However, in some embodiments, the top surface 333 can have a laser cut feature, such as a surface ablation. An oxide layer can be formed on the ablated portion of the top surface 333 of the first laminate section 331.

Further, as depicted in FIG. 28, the second laminate section 332 defines an opening or through hole 334 that extends from a top surface 337 to a bottom surface 338 of the second laminate section 332. The through hole 334 is formed at least in part by a laser cutting process. Particularly, as shown, the second laminate section 332 is laser cut such that the second laminate section 332 is hollow. Notably, the second laminate section 332 has laser cut features 336 on its interior sidewalls. Each interior sidewall has an oxide layer 339 formed thereon.

When the second laminate section 332 and the first laminate section 331 are laid up to form the laminate component 390 as shown in FIG. 29, the through hole 334 is now enclosed by the top surface 333 of the first laminate section 331. In this way, a recess is formed. The second laminate section 332 forms the perimeter of the formed recess. As each of the interior sidewalls of the second laminate section 332 have oxide layers 339 formed thereon, the interior sidewalls of the formed recess likewise have oxide layers formed thereon. The oxide layers can facilitate control of the surface geometry supporting post-MI coating.

In addition, the laser cut features described herein with oxide layers formed thereon can provide stress reduction and shielding features at the as-molded level that carry into the finished part without additional machining. Weight can be reduced while minimizing machining cost. Retention features (bolt holes, pin slots, anti-rotation features, seal slots, dovetails), balance lands, cooling passages, and other features can be formed to remain as-molded or be fabricated in a near-net shape to support follow-on finish machining.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. A method of forming a laminate component, the method comprising: laser cutting a laminate section formed of one or more plies to define a feature having one or more surfaces, wherein laser cutting the laminate section forms an oxide layer on the one more surfaces of the feature; and infiltrating the laminate section with an infiltration material, wherein when the first laminate section is infiltrated with the infiltration material, the oxide layer formed on the one or more surfaces of the feature prevents the infiltration material from infiltrating therethrough.

2. The method of any preceding clause, wherein the one or more plies are formed of a CMC material.

3. The method of any preceding clause, wherein the oxide layer is a silicon oxide layer.

4. The method of any preceding clause, wherein the infiltration material comprises silicon.

5. The method of any preceding clause, further comprising: curing the laminate section at elevated temperature and pressure in an autoclave.

6. The method of any preceding clause, wherein laser cutting the laminate section formed of the one or more plies to define the feature having the one or more surfaces occurs prior to curing the laminate section at elevated temperature and pressure in the autoclave.

7. The method of any preceding clause, wherein laser cutting the laminate section formed of the one or more plies to define the feature having the one or more surfaces occurs after curing the laminate section at elevated temperature and pressure in the autoclave.

8. The method of any preceding clause, wherein laser cutting the laminate section takes place in an atmosphere.

9. The method of any preceding clause, wherein the laminate section is a first laminate section, and wherein the method further comprises: laser cutting a second laminate section formed of one or more plies to define a feature having one or more surfaces, wherein laser cutting the second laminate section forms an oxide layer on the one more surfaces of the feature of the second laminate section; and laying up the second laminate section so that the feature of the second laminate section and the feature of the first laminate section define a cavity, and wherein during infiltrating, the first laminate section and the second laminate section are infiltrated with the infiltration material and the oxide layer formed on the one or more surfaces of the feature of the first laminate section and the oxide layer formed on the one or more surfaces of the second laminate section prevent the infiltration material from infiltrating into the cavity.

10. The method of any preceding clause, wherein the feature laser cut into the laminate section is a channel with one or more turbulators projecting into the channel.

11. The method of any preceding clause, wherein the laminate section has an external surface, and wherein the feature is laser cut along the external surface of the laminate section.

12. A method of forming a laminate component, the method comprising:

laser cutting a first laminate section to define a feature having one or more surfaces, wherein laser cutting the first laminate section forms an oxide layer on the one more surfaces of the feature; laser cutting a second laminate section to define a feature having one or more surfaces, wherein laser cutting the second laminate section forms an oxide layer on the one more surfaces of the feature of the second laminate section; laying up the second laminate section so that the second laminate section and the first laminate section form at least a portion of the laminate component and so that the feature of the second laminate section is positioned in communication with the feature of the first laminate section; and infiltrating the laminate component with an infiltration material.

13. The method of any preceding clause, wherein the first laminate section is formed of one or more CMC plies and the second laminate section is formed of one or more CMC plies.

14. The method of any preceding clause, further comprising: laser cutting a third laminate section to define a feature having one or more surfaces, wherein laser cutting the third laminate section forms an oxide layer on the one more surfaces of the feature of the third laminate section; and laying up the third laminate section so that the third laminate section forms at least a portion of the laminate component and so that the feature of the third laminate section is positioned in communication with the feature of the second laminate section, and wherein during infiltrating, the oxide layer formed on the one or more surfaces of the feature of the third laminate section prevents the infiltration material from infiltrating therethrough.

15. The method of any preceding clause, wherein the first laminate section extends between a first side and a second side, the second laminate section extends between a first side and a second side, and the third laminate section extends between a first side and a second side, and wherein the feature defined by the first laminate section is a surface ablation, the feature defined by the second laminate section is a channel aligned with the surface ablation of the first laminate section, the channel having a depth extending between the first side and the second side of the second laminate section, and the feature defined by the third laminate section is a through hole aligned at least in part with the channel of the second laminate section, the through hole having a depth extending between the first side and the second side of the third laminate section.

16. The method of any preceding clause, further comprising: laser cutting the third laminate section to define a second feature having one or more surfaces, wherein the second feature is a surface ablation defined along the first side of the third laminate section, the surface ablation having a shape complementary to the channel of the second laminate section, and wherein laser cutting the third laminate section forms an oxide layer along the one or more surfaces of the surface ablation at the first side of the third laminate section, and wherein during laying up, the surface ablation is positioned in communication with the channel of the second laminate section.

17. The method of any preceding clause, wherein the through hole, the surface ablation of the third laminate section, the channel, and the surface ablation of the first laminate section define a cavity of the laminate component, and wherein the oxide layers formed on the one or more surfaces that define the through hole, the surface ablation of the third laminate section, the channel, and the surface ablation of the first laminate section prevent the infiltration material from infiltrating into the cavity during infiltrating.

18. The method of any preceding clause, wherein after infiltrating the laminate component with the infiltration material during infiltrating, the method further comprises: machining one or more cooling holes into at least one of the first laminate section, the second laminate section, and the third laminate section such that the cooling holes extend from the cavity to an outer surface of the laminate component.

19. The method of any preceding clause, wherein the laminate component is a flowpath component of a gas turbine engine.

20. A method of forming a CMC laminate component for a turbine engine, the method comprising: laser cutting a first laminate section formed of one or more CMC plies to define a feature having one or more surfaces, wherein laser cutting the first laminate section forms an oxide layer on the one more surfaces of the feature; laser cutting a second laminate section formed of one or more CMC plies to define a feature having one or more surfaces, wherein laser cutting the second laminate section forms an oxide layer on the one more surfaces of the feature of the second laminate section; laser cutting a third laminate section formed of one or more CMC plies to define a feature having one or more surfaces, wherein laser cutting the third laminate section forms an oxide layer on the one more surfaces of the feature of the third laminate section; laying up the first, second, and third laminate sections to form at least a portion of the CMC laminate component and so that the feature of the first laminate section is in communication with the second laminate section and the feature of the second laminate section is in communication with the feature of the third laminate section in such a way that the feature of the first laminate section, the feature of the second laminate section, and the feature of the third laminate section define a cavity; and infiltrating the CMC laminate component with an infiltration material, wherein when the CMC laminate component is infiltrated with the infiltration material, the oxide layers formed on the one or more surfaces of the features of the first laminate section, the second laminate section, and the third laminate section prevent the infiltration material from infiltrating into the cavity.

What is claimed:

1. A method of forming a laminate component, the method comprising:
laser cutting a laminate section formed of one or more plies to define a feature having one or more surfaces, wherein laser cutting the laminate section forms an oxide layer on the one more surfaces of the feature; and
infiltrating the laminate section with an infiltration material, wherein when the first laminate section is infiltrated with the infiltration material, the oxide layer formed on the one or more surfaces of the feature prevents the infiltration material from infiltrating therethrough.

2. The method of claim 1, wherein the one or more plies are formed of a CMC material.

3. The method of claim 1, wherein the oxide layer is a silicon oxide layer.

4. The method of claim 1, wherein the infiltration material comprises silicon.

5. The method of claim 1, further comprising:
curing the laminate section at elevated temperature and pressure in an autoclave.

6. The method of claim 5, wherein laser cutting the laminate section formed of the one or more plies to define the feature having the one or more surfaces occurs prior to curing the laminate section at elevated temperature and pressure in the autoclave.

7. The method of claim 5, wherein laser cutting the laminate section formed of the one or more plies to define the feature having the one or more surfaces occurs after curing the laminate section at elevated temperature and pressure in the autoclave.

8. The method of claim 1, wherein laser cutting the laminate section takes place in an atmosphere.

9. The method of claim 1, wherein the laminate section is a first laminate section, and wherein the method further comprises:
laser cutting a second laminate section formed of one or more plies to define a feature having one or more surfaces, wherein laser cutting the second laminate section forms an oxide layer on the one more surfaces of the feature of the second laminate section; and
laying up the second laminate section so that the feature of the second laminate section and the feature of the first laminate section define a cavity, and
wherein during infiltrating, the first laminate section and the second laminate section are infiltrated with the infiltration material and the oxide layer formed on the one or more surfaces of the feature of the first laminate section and the oxide layer formed on the one or more surfaces of the second laminate section prevent the infiltration material from infiltrating into the cavity.

10. The method of claim 1, wherein the feature laser cut into the laminate section is a channel with one or more turbulators projecting into the channel.

11. The method of claim 1, wherein the laminate section has an external surface, and wherein the feature is laser cut along the external surface of the laminate section.

12. A method of forming a laminate component, the method comprising:
laser cutting a first laminate section to define a feature having one or more surfaces, wherein laser cutting the first laminate section forms an oxide layer on the one more surfaces of the feature;
laser cutting a second laminate section to define a feature having one or more surfaces, wherein laser cutting the second laminate section forms an oxide layer on the one more surfaces of the feature of the second laminate section;
laying up the second laminate section so that the second laminate section and the first laminate section form at least a portion of the laminate component and so that the feature of the second laminate section is positioned in communication with the feature of the first laminate section; and
infiltrating the laminate component with an infiltration material.

13. The method of claim 12, wherein the first laminate section is formed of one or more CMC plies and the second laminate section is formed of one or more CMC plies.

14. The method of claim 12, further comprising:
laser cutting a third laminate section to define a feature having one or more surfaces, wherein laser cutting the third laminate section forms an oxide layer on the one more surfaces of the feature of the third laminate section; and
laying up the third laminate section so that the third laminate section forms at least a portion of the laminate component and so that the feature of the third laminate section is positioned in communication with the feature of the second laminate section, and
wherein during infiltrating, the oxide layer formed on the one or more surfaces of the feature of the third laminate section prevents the infiltration material from infiltrating therethrough.

15. The method of claim 14, wherein the first laminate section extends between a first side and a second side, the second laminate section extends between a first side and a second side, and the third laminate section extends between a first side and a second side, and wherein the feature defined by the first laminate section is a surface ablation, the feature defined by the second laminate section is a channel aligned with the surface ablation of the first laminate section, the channel having a depth extending between the first side and the second side of the second laminate section, and the feature defined by the third laminate section is a through hole aligned at least in part with the channel of the second laminate section, the through hole having a depth extending between the first side and the second side of the third laminate section.

16. The method of claim 15, further comprising:
laser cutting the third laminate section to define a second feature having one or more surfaces, wherein the second feature is a surface ablation defined along the first side of the third laminate section, the surface ablation having a shape complementary to the channel of the second laminate section, and wherein laser cutting the third laminate section forms an oxide layer along the one or more surfaces of the surface ablation at the first side of the third laminate section, and
wherein during laying up, the surface ablation is positioned in communication with the channel of the second laminate section.

17. The method of claim 16, wherein the through hole, the surface ablation of the third laminate section, the channel, and the surface ablation of the first laminate section define a cavity of the laminate component, and wherein the oxide layers formed on the one or more surfaces that define the through hole, the surface ablation of the third laminate section, the channel, and the surface ablation of the first laminate section prevent the infiltration material from infiltrating into the cavity during infiltrating.

18. The method of claim 17, wherein after infiltrating the laminate component with the infiltration material during infiltrating, the method further comprises:
machining one or more cooling holes into at least one of the first laminate section, the second laminate section, and the third laminate section such that the cooling holes extend from the cavity to an outer surface of the laminate component.

19. The method of claim 12, wherein the laminate component is a flowpath component of a gas turbine engine.

20. A method of forming a CMC laminate component for a turbine engine, the method comprising:
laser cutting a first laminate section formed of one or more CMC plies to define a feature having one or more surfaces, wherein laser cutting the first laminate section forms an oxide layer on the one more surfaces of the feature;
laser cutting a second laminate section formed of one or more CMC plies to define a feature having one or more surfaces, wherein laser cutting the second laminate section forms an oxide layer on the one more surfaces of the feature of the second laminate section;
laser cutting a third laminate section formed of one or more CMC plies to define a feature having one or more surfaces, wherein laser cutting the third laminate section forms an oxide layer on the one more surfaces of the feature of the third laminate section;
laying up the first, second, and third laminate sections to form at least a portion of the CMC laminate component and so that the feature of the first laminate section is in communication with the second laminate section and the feature of the second laminate section is in communication with the feature of the third laminate section in such a way that the feature of the first laminate section, the feature of the second laminate section, and the feature of the third laminate section define a cavity; and
infiltrating the CMC laminate component with an infiltration material, wherein when the CMC laminate component is infiltrated with the infiltration material, the oxide layers formed on the one or more surfaces of the features of the first laminate section, the second laminate section, and the third laminate section prevent the infiltration material from infiltrating into the cavity.
